(19) United States
(12) Patent Application Publication
(10) Pub. No.: US 2009/0093907 A1
(43) Pub. Date: Apr. 9, 2009

(54) Robot System

(76) Inventors: Ryoso Masaki, Narashino (JP); Toshio Moriya, Tokyo (JP); Kosei Matsumoto, Yokohama (JP); Junichi Tamamoto, Kasumigaura (JP); Motoya Taniguchi, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/180,755

(22) Filed: Jul. 28, 2008

(30) Foreign Application Priority Data
Oct. 5, 2007 (JP) 2007-261517

(51) Int. Cl. G06F 17/00

(52) U.S. Cl. 700/248; 700/258; 901/1; 901/46

(57) ABSTRACT

In a robot system constructed by a superior controller and a robot, it is necessary to carry out a high-speed computation in a system which simultaneously generate a map together with identifying a posture of the robot, there is a problem that the robot system becomes expensive because a computing load becomes enlarged, and it is an object to reduce the computing load. In order to achieve the object, there is provided a robot system constructed by a controller having a map data and a mobile robot, in which the robot is provided with a distance sensor measuring a plurality of distances with respect to a peripheral object, and an identifying apparatus identifying a position and an angle of the robot by collating with the map data, and the controller is provided with a map generating apparatus generating or updating the map data on the basis of the position and the angle of the robot, and the measured distance with respect to the object. Accordingly, it is possible to reduce the computing load of the controller and the robot, and it is possible to achieve a comparatively inexpensive robot system.

### INCORPORATION BY REFERENCE

The present application claims priority from Japanese application JP2007-261517 filed on Oct. 5, 2007, the content of which is hereby incorporated by reference into this application.

### BACKGROUND OF THE INVENTION

(1) Field of the Invention

The present invention relates to a mobile robot system, and more particularly to a mobile robot system having a function of generating and updating a map.

(2) Description of Related Art

There has been proposed a method structured such that a mobile robot measures a peripheral state, and simultaneously generates a map while estimating a self position on the basis of the data. Since this method is a technique called as a simultaneous localization and mapping (SLAM), and the robot can estimate the self position while generating the map, even in the case that the robot is set under an environment having no map information, this method has a feature of moving in a self-sustaining manner.

For example, in patent document 1 (JP-A-2004-276168), there is shown a method of generating a novel map information by simultaneously estimating a map information expressed by a relative posture between objects and a posture of the robot by a mobile sensor and a recognizing means of the mobile robot. Further, in patent document 2 (JP-A-2005-332204), there is described a self position detecting means such as a global positioning system (GPS) or the like, an object detecting means detecting a distance and a direction with respect to a peripheral object, and a mobile control apparatus provided with a function of generating an environmental map in a moving direction on the basis of the detected data. Further, in patent document 3 (JP-A-2007-94743), there is shown a structure in which a map data generating portion and a position estimating portion are arranged in a self-sustaining mobile type robot or a server apparatus.

The robot systems shown by these known arts can be divided into two cases in accordance with an arranged method of the map generating portion generating the map and the self position estimating portion estimating the self position of the robot. One method corresponds to a case that the map generating portion and the self position estimating portion are incorporated in the robot, and the other method corresponds to a case that they are incorporated in a superior controller (a server apparatus) controlling a motion of the robot. In this case, in the case of the robot system aiming at the map generation itself, since it is not necessary that the robot operates in a self-sustaining manner, a vehicle operated or pushed by a human being is called as the robot of the present invention.

In the former case, there is a problem that a memory apparatus storing the map is enlarged in size as well as a computing load of the robot controller incorporated in the robot becomes very large. Particularly, in the system in which a plurality of robots simultaneously operate, in the case of mutually utilizing the maps generated by the respective robots, it is necessary to regenerate a wide map while outputting the map information of each of the robots to the superior controller, and securing a consistency of the maps by the superior controller. Accordingly, it is necessary to communicate enormous data so as to carry out a high-speed computing process by the superior controller.

Further, in the latter case, since the map is generated while transmitting the peripheral environmental information (an image, an obstacle detection, a sensor information of the moving mechanism and the like) obtained by the robot to the superior controller, and estimating the position, it takes a long time to transmit and receive between the superior controller and the robot in the case of controlling so as to move the robot on the basis of the peripheral environmental information, and there is a problem that it is impossible to carry out a robot traveling control having a high-speed response. Further, in the case of operating a plurality of robots in accordance with this method, there is a problem that the superior controller requires a high-speed and high-performance computing process, for computing the robot traveling control.

### BRIEF SUMMARY OF THE INVENTION

The present invention is made by taking the problem mentioned above into consideration, and an object of the present invention is to provide a robot system in which a superior controller is comparatively inexpensive even in the case of driving a plurality of robots, as well as reducing a computing load while securing a high response performance of the robot.

### MEANS FOR SOLVING THE PROBLEM

In order to achieve the object mentioned above, the following correspondence is intended.

There is provided a robot system constructed by a controller having a map data and a mobile robot, wherein the robot includes a distance sensor measuring a plurality of distances with respect to a peripheral object, and an identifying apparatus identifying a position and an angle of the robot by collating with the map data, and the controller includes a map generating apparatus generating or updating the map data on the basis of the position and the angle of the robot, and the measured distance with respect to the object.

Accordingly, it is possible to achieve a comparatively inexpensive robot system which can reduce a computing load of the controller and the robot. Particularly, even in the case of the robot system constructed by a plurality of robots, it is possible to achieve the system without enhancing a performance of a superior controller very much.

In accordance with the present invention, there can be provided a robot system constructed by a controller having a map data and a plurality of mobile robots, wherein the robot identifies a position and an angle of the robot by measuring a plurality of distances with respect to a peripheral object, and collating the map data input from the controller, and the controller generates or updates the map data on the basis of the distance with respect the object measured by the plurality of robots and the position and angle.

Further, in accordance with the present invention, there is provided a robot system constructed by a controller having a map data and a mobile robot, wherein the robot includes a distance sensor measuring a plurality of distances with respect to a peripheral object, a data selecting apparatus selecting a region map data near the robot in the map data, and an identifying apparatus identifying a position and an angle of the robot by collating the region map with the distance, and the controller includes a map generating apparatus generating or updating the map data on the basis of the position and the angle of the robot, and the measured distance with respect to the object.

Further, in accordance with the present invention, there is provided a robot system constructed by a controller having a map data and a mobile robot, wherein the robot includes a distance sensor measuring a plurality of distances with respect to a peripheral object, a memory apparatus storing a region map data near the robot in the map data, and an identifying apparatus identifying a position and an angle of the robot by collating the region map with the distance, and the controller includes a map generating apparatus generating or updating the map data on the basis of the position and the angle of the robot, and the measured distance with respect to the object.

In the robot system in accordance with the present invention, it is preferable that the distance sensor is constituted by a laser distance meter.

In the robot system in accordance with the present invention, it is preferable that the robot moves in a self-sustaining manner on the basis of the position and the angle of the robot and a motion instruction from the controller, after identifying the position and the angle of the robot.

In the robot system in accordance with the present invention, it is preferable that the plurality of robots mutually identify the positions of the robots.

In the robot system in accordance with the present invention, it is preferable that the region map data is changed on the basis of the identified position of the robot.

In the robot system in accordance with the present invention, it is preferable that the region map data is changed at a time when the position of the robot is moved at a predetermined distance or more from the position of the robot at a time of selecting or storing the region map data.

Further, there is provided a robot system constructed by a controller having a map data and a mobile robot, wherein the robot includes a distance sensor measuring a plurality of distances with respect to a peripheral object, a data selecting apparatus selecting a region map data near the robot in the map data, and an identifying apparatus identifying a position and an angle of the robot by collating the region map data with the distance. Therefore, there can be provided the robot system in which the robot is activated in a further wide range of region, and it is possible to achieve the object mentioned above.

### EFFECT OF THE INVENTION

In accordance with the present invention, since it is possible to reduce a computing load of a robot and a controller, there can be obtained a comparatively inexpensive robot system controlling a robot having a high response.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWING

FIG. 1 is a block diagram showing a system structure of an embodiment 1;

FIG. 2 is a map showing a moving way of a robot and a range measuring an object distance;

FIG. 3 is a relation view showing a state at a time of measuring a distance between an initial posture of the robot and the object as seen from an upper portion;

FIG. 4 is a relation view showing a state at a time of collating a map data with the measured distance so as to identify a position and an angle of the robot as seen from an upper portion;

FIG. 5 is a flow chart showing a processing method of identifying the posture of the robot;

FIG. 6 is a relation view showing a map generating method of detecting a new object on the basis of the identified posture of the robot and the measured distance data;

FIG. 7 is a relation view showing a relation between an actual robot and an actual object as seen from an upper portion;

FIG. 8 is a flow chart carrying out a computation of the map generation;

FIG. 9 is a block diagram showing a system structure at a time when a plurality of robots are activated, in the other embodiment which is different from FIG. 1;

FIG. 10 is a flow chart carrying out the map generation by a plurality of robots;

FIG. 11 is a flow chart of an embodiment which is different from FIG. 10 and to which a function that a plurality of robots mutually identify the position is added;

FIG. 12 is a relation view showing a state at a time when a robot 22 measures a distance with respect to an object as seen from an upper portion;

FIG. 13 is a relation view showing a state at a time when a robot 21 measures a distance with respect to an object as seen from an upper portion;

FIG. 14 is a relation view showing a range in which the robots mutually measure as seen from an upper portion; and

FIG. 15 is a block diagram showing a structure of a robot system operating in a wide range of motion region.

### DETAILED DESCRIPTION OF THE INVENTION

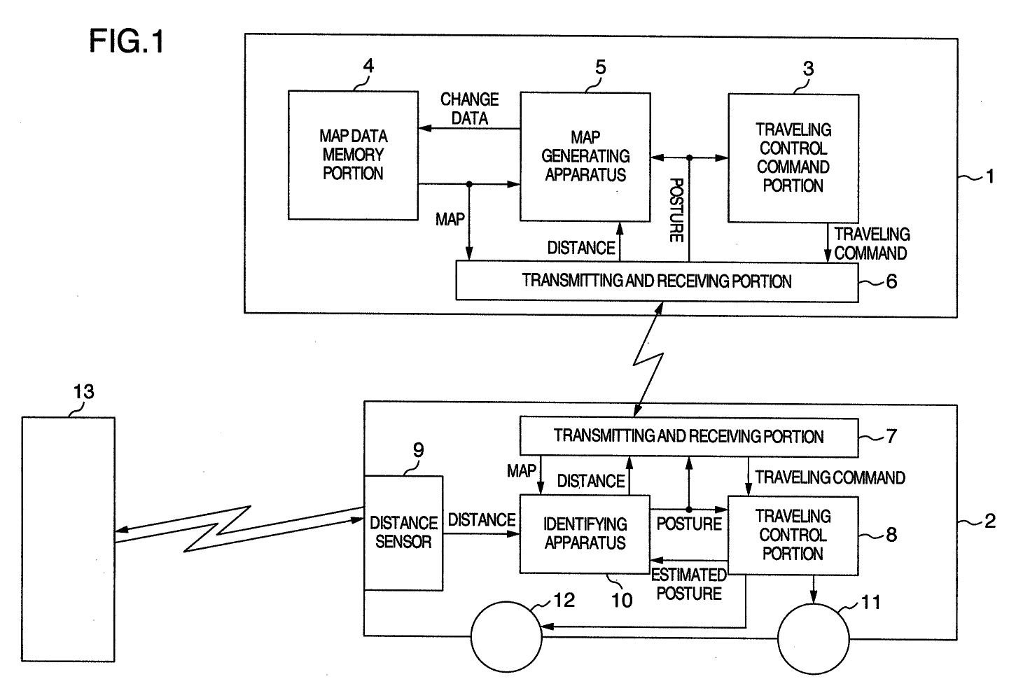

A description will be given of an embodiment in accordance with the present invention with reference to FIGS. 1 to 14.

FIG. 1 is a block diagram of a robot system constructed by a superior controller 1 which is characteristic in the present invention, and one mobile robot 2. The controller 1 is constituted by a traveling control command portion 3 outputting a traveling command of the robot 2, a map data memory portion 4 storing a map of a region in which the robot 2 travels, a map generating apparatus 5 carrying out a map generation, and a transmitting and receiving portion 6 transmitting and receiving the data with respect to the robot 2. Further, the robot 2 is constituted by a transmitting and receiving portion 7 carrying out a communication with the superior controller 2, a traveling control portion 8 controlling a traveling state of the robot 2 on the basis of the traveling command output from the controller 1, a distance sensor 9 measuring a distance d between the robot 2 and a peripheral object 13, an identifying apparatus 10 identifying a self position of the robot 2 on the basis of the map data input from the controller 1, and wheels 11 and 12 traveling the robot 2.

In this case, a position of the robot 2 in an absolute coordinate system (x-y stationary coordinate system) is set to (xr, yr), and an angle of the robot 2 is expressed by θr. Further, the robot position (xr, yr) and the angle θr are called as a posture of the robot 2 together.

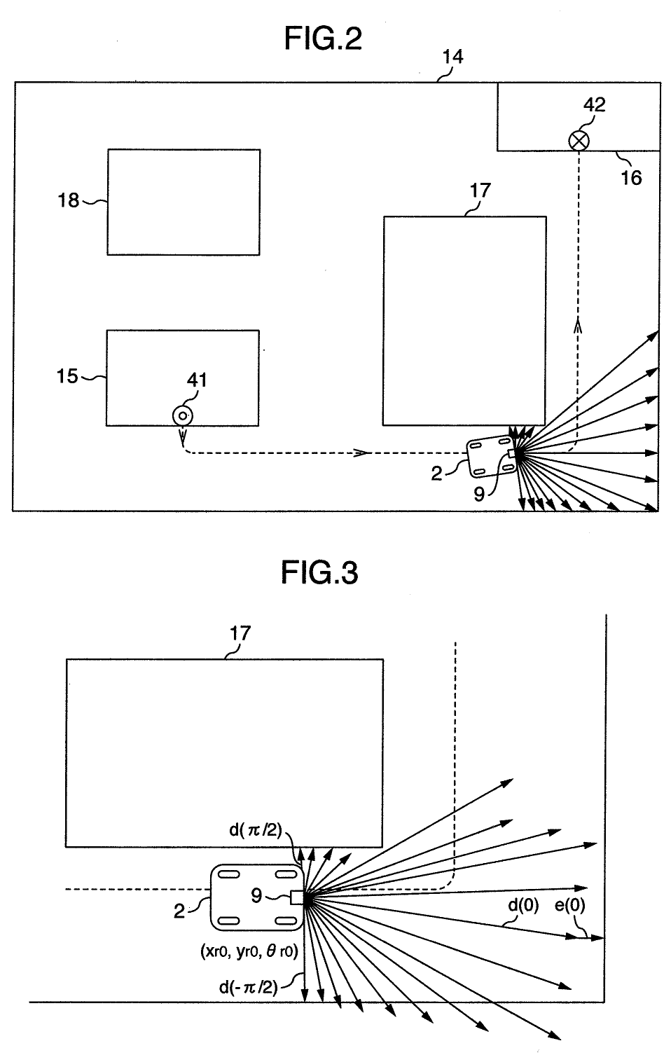

First, a description will be given of an operation relating to the traveling control of the robot 2 with reference to FIGS. 1 and 2. FIG. 2 is a state view showing one example of a state in which the robot moves in an operating region 14 as seen from an upper portion. The operating region 14 in FIG. 2 is surrounded by a wall, and the robot 2 can travel in the other region (that is, a passage) while avoiding objects 15, 16, 17 and 18. In this case, the objects 15, 16, 17 and 18 mean a working table, a room, a wall or the like, however, in order to simplify an explanation, they are called as the object of the working table. FIG. 2 shows a state in process of moving the robot 2 from a starting point 41 or the working table 15 to a reaching point 42.

In the traveling control command portion 3 of the controller 1, if a command is given from a human being, or a command or the like is given from a superior robot operation control system which is not mentioned, the traveling control command portion 3 moves the robot 2 to the starting point 41 on the basis of the robot position (xr, yr) obtained from the commands and the posture of the robot 2, thereafter plans a traveling path of the robot to the reaching point 42, and outputs a path shown by a broken line such as FIG. 2 as the traveling command to the traveling control portion 8 of the robot 2. The traveling control portion 8 inputs the posture of the robot 2 output from an identifying apparatus 10 mentioned below to the traveling command, carried out a feedback control, and controls a traveling speed of the wheels 11 and 12, and a steering angle. Accordingly, the robot 2 can move to the reaching point 42 according to the path shown by the broken line in FIG. 2. Further, the traveling control portion 8 geometrically estimates the posture of the robot 2 from the posture of the input robot 2, and the distance and the angle at which the robot is thereafter moved in accordance with the traveling control. However, since there exists a slip of the wheels 11 and 12, the posture may be different from an actual posture of the robot 2. Accordingly, the posture of the robot 2 which is calculated by the traveling control portion 8 is hereinafter called as an estimated posture.

Next, a description will be given of the distance sensor 9 in FIG. 1. A range measured by the distance sensor 9 is shown in FIG. 2. The distance sensor 9 used in this embodiment is called as a laser distance meter, and is attached to a front side of the robot 2. It is possible to measure a distance d from the robot 2 to the peripheral object in a range of ±90 degree at the center of the front face of the robot 2, that is, in a range of 180 degree by this distance sensor 9. In the case of FIG. 2, there is shown a state of measuring the distance d to the wall of the operating region 14 or the object 17 with respect to each of angles seen from the robot 2.

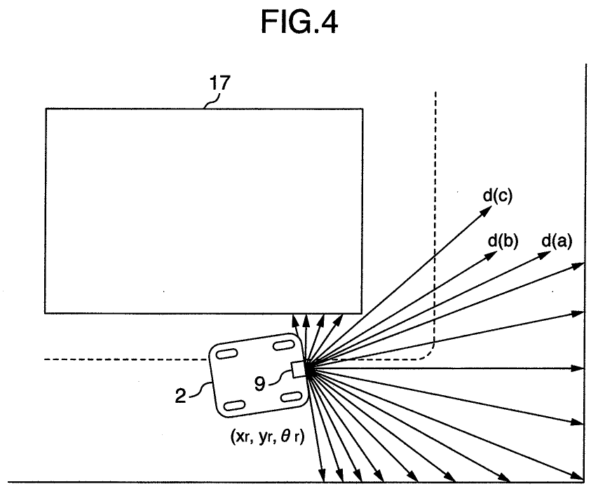

In this case, a description will be given of a processing content in the identifying apparatus 10 in FIG. 1 with reference to FIGS. 3 to 8. The estimated posture calculated by the traveling control portion 8 is input to the identifying apparatus 10. In the identifying apparatus 10, the input estimated posture is defined as an initial posture (xr0, yr0, θr0), and a description will hereinafter follows to this. If the initial posture (xr0, yr0, θr0) is regarded as the posture of the robot 2, and the measured distance d is expanded on the map, FIG. 3 is obtained. In this case, this map is input to the identifying apparatus 10 from the map memory portion 4 of the controller 1. In accordance with FIG. 3, it is known that the data of the distance d and the map are largely deviated in a lower side and a right side of the wall of the operating region 14. If the data of the distance d approximately comes into line with the map as shown in FIG. 4, this means that the posture (xr, yr, θr) of the robot 2 indicates an actual posture at a time of measuring the distance d. The initial posture (xr0, yr0, θr0) is the value estimated by the traveling control portion 8, and the case of FIG. 3 means that the initial posture is different from the actual posture (xr, yr, θr) of the robot 2.

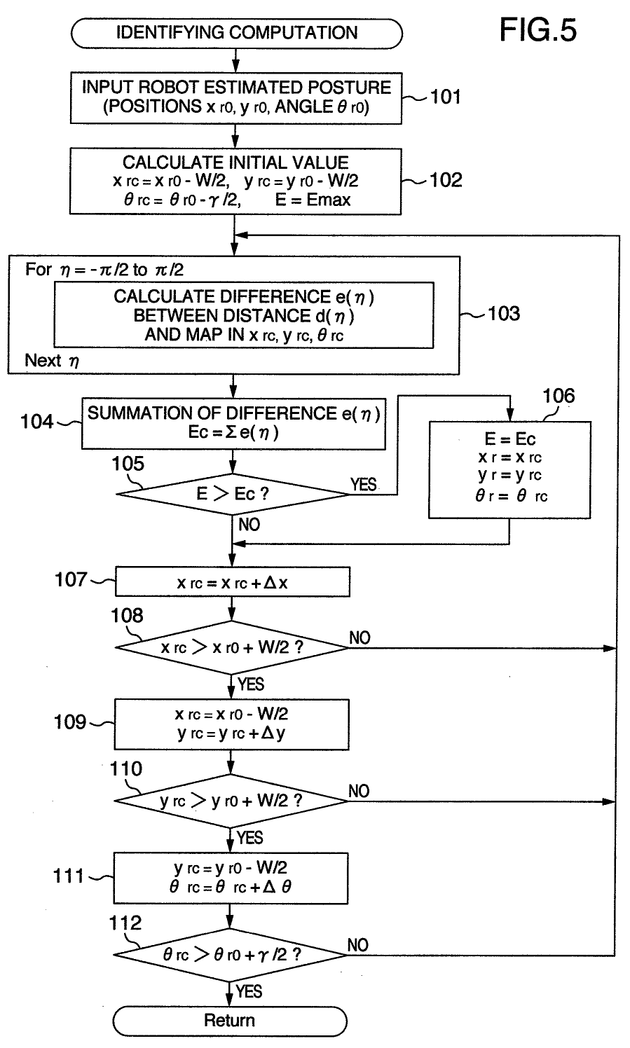

In this case, a description will be given of a computing method of the identifying apparatus 10 determining the actual posture (xr, yr, θr) of the robot 2 on the basis of the initial posture (xr0, yr0, θr0) with reference to FIG. 5, on the assumption that the initial posture (xr0, yr0, θr0) exists in the vicinity of the actual posture (xr, yr, θr). In this case, determined parameters are constituted by three parameters including the positions xr and yr, and the angle θr. Among them, with regard to the x axis and the y axis, there is set a distance search value w which is larger than a value at which a difference between xr0 and xr and a difference between yr0 and yr may become maximum. Further, with regard to the θ direction, there is set an angle search value γ which is larger than a value at which a difference between θr0 and θr may become maximum.

When each of the values of the initial posture (xr0, yr0, θr0) simultaneously comes into line with the actual posture (xr, yr, θr), the map approximately comes into line with the data of the distance d, as shown in FIG. 4. In other words, a value of a sum of errors from the data of a plurality of distances d to the map becomes minimum, in a state of FIG. 4. This is determined in accordance with a searching method as follows.

A step 101 inputs the estimated posture of the robot, that is, the initial posture (xr0, yr0, θr0). A step 102 calculates an initial value (xrc, yrc, θrc) for searching, with regard to three parameters, as shown in FIG. 5. Further, a summation E of the differences is set to a summation maximum value Emax. The summation maximum value Emax is set to a value which is far larger than the maximum value in the value Ec calculated by steps 103 and 104 shown below. The step 103 determines a difference e(η) between the distance d(η) and the map on the assumption that the posture of the robot is (xrc, yrc, θrc). In this case, the distance (η) expresses the distance of the angle η measured by the distance sensor 9. Further, e(η) indicates the difference from the map data which is closest to the distance d(η), in the data of the map. For example, in FIG. 3, in e(0) with respect to the distance d(0) in the case of η=0, the minimum distance to the right wall of the operating region 14 comes to the value, as illustrated. The step 103 calculates the error e(η) from −90 degree to +90 degree of the angle η. The next step 104 determines the summation Ec of the errors e(η) from −90 degree to +90 degree of the angle η.

In the case that the summation Ec is smaller than the summation E, as a result of comparing the summation E with the summation Ec in a step 105, a process in a step 106 is carried out. In the case that the summation Ec is equal to or more than the summation E, the step directly jumps to a step 107. The process of the step 106 sets the summation Ec, the positions xrc and yrc, and the angle θrc respectively to the summation E, the positions xr and yr, and the angle θr. The process of the step 106 means storing the positions xrc and yrc and the angle θrc of the smallest summation Ec in the summation Ec calculated in the step 104 as the positions xr and yr and the angle θr. After the process of the step 106 is finished, the step jumps to the step 107.

The calculation in the step 107 resets the position xrc as the position xrc by adding only an x-axis calculation width Δx. It is desired to set the x-axis calculation width Δx to a small value which is considered from a precision and a calculated amount of the posture (xr, yr, θr) obtained by identifying. The same matter is applied to a y-axis calculation width Δy, and an angle calculation width Δθ.

A step 108 determines whether or not the position xrc reaches xr0+W/2, and repeats the processes from the step 103 to the step 107 if the position xrc is equal to or less than xr0+W/2. The processes up to here are provided for carrying out the calculation of the summation Ec per the x-axis calculation width Δx from xr0−W/2 to xr0+W/2 of the position xrc, in a state of setting the position yrc and the angle θrc constant, and determining the minimum value in the range. In the case that the step 108 determines that the position xrc gets over xr0+W/2, it means that the position xrc is out of the distance searching region. Accordingly, the step jumps to a step 109, and replaces the position yrc to the position yrc obtained by adding only the y-axis calculation width Δy to the initial value xr0−W/2 of the position xrc. A step 110 determines whether or not the position yrc reaches yr0+W/2 in the same manner as the step 108, and repeats the processes from the step 103 to the step 109 if the position yrc is equal to or less than yr0+W/2. As a result, it is possible to determine the minimum value in a whole region of the distance searching region in the x-axis and y-axis directions by setting θrc as a fixed value, in the summation E. Accordingly, it is possible to obtain the posture (xr, yr, θr) of the robot in which the summation in the range becomes minimum.

In the case that the step 110 determines that the position yrc gets over yr0+W/2, a process shown in a step 111 in FIG. 5 is carried out. In other words, the position yrc is replaced to the initial value yr0−W/2, and the position θrc is replaced to the position θrc obtained by adding only the angle calculation width AO. Next, a step 112 determines whether or not the angle θrc reaches θr0+y/2, and repeats the processes from the step 103 to the step 111 in the case that the angle θrc is equal to or less than θr0+y/2. In the case that the angle θrc gets over θr0+y/2, the identifying computation is finished. It is possible to calculate all the summations Ex in the range of the x-axis and y-axis distance searching value W and the range of the angle searching value y in the direction θ, and decides the minimum Ec as the summation E, by carrying out the processes mentioned above. At that time, it is possible to identify that the stored positions xr and yr, and angle θr is the actual posture (xr, yr, θr) of the robot. FIG. 4 shows a result at that time.

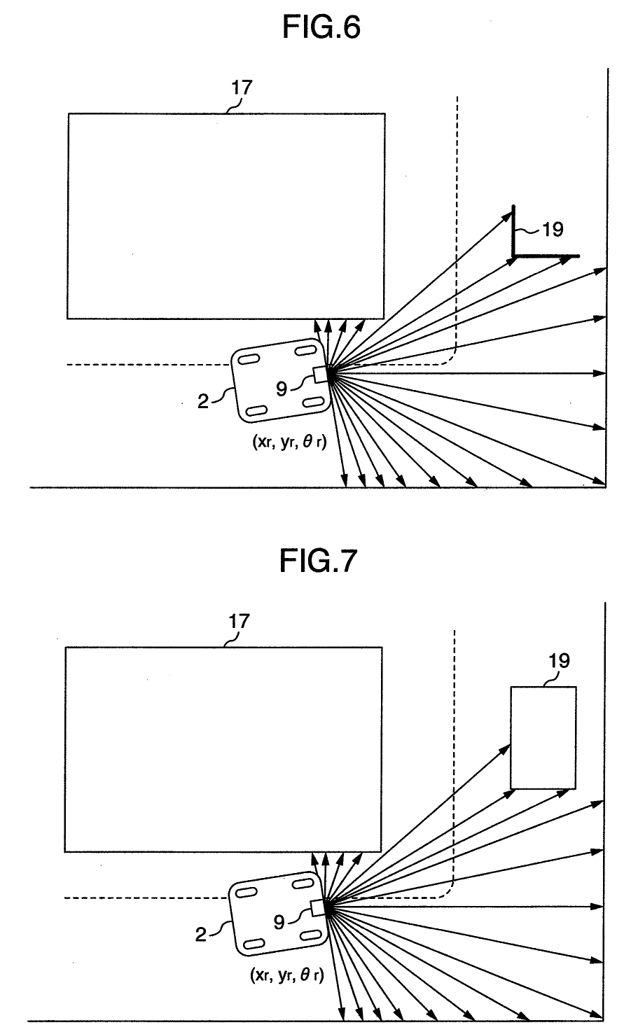

FIG. 4 means a fact that data d(a), d(b) and d(c) which does not apparently come into line with the map exist in the data of the distance d, in a right side of FIG. 4, and some kind or another object which is not shown in the map exists in the place. For example, there can be considered a case that the object is arranged in accordance with a layout change. In the present embodiment, a description will be given of a case that the certain object 19 exists between the right wall of the operating region 14 and the object 17 in FIG. 7. As a result of FIG. 4, a part of the new object 19 is detected, as shown in FIG. 6. In the map generating apparatus 5 of the controller 1, the map is generated and updated on the basis of the information.

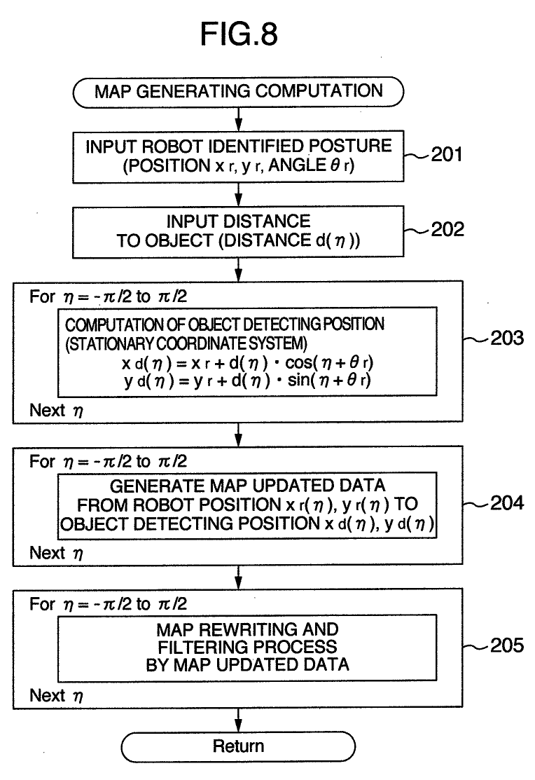

A description will be given of the computing method by using a flow chart in FIG. 8. First, a step 201 inputs the posture (xr, yr, θr) of the robot 2, and a step 202 inputs the distance d obtained by the distance sensor 9. The next step 203 determines a position (a stationary coordinate system) of the object detected within the range of ±90 degree from the robot 2, that is, the object detection position (xd(η, yd(η)), on the basis of the distance d(η) to the object with respect to the angle η. A computation scale width Δη of the angle η is decided on the basis of a data number of the distance sensor 9, a computation processing time and the like, and the repeated computations of the steps 203, 204 and 205 are carried out per the computation scale width Δη. The computation in the step 204 is structured such as to generate the map updated data from the robot position (xr(η), yr(η)) to the object detection position (xd(η), yd(η)). In the case of detecting the distance from the robot 2 to the position of the object, not only the step detects the position at which the object exists, but also the step measures that the other objects do not exist from the robot 2 to the detected position of the object. Accordingly, the step 204 generates the map updated data including the range in which the object does not exist, in addition to the position of the object. The step 205 carries out a rewriting operation and a filtering process computation per element of the map data by using the map updated data. The changed data of the map obtained as a result thereof is output to the map data memory portion 4.

In accordance with the process mentioned above, the robot 2 identifies the posture of the robot 2 on the basis of the collected distance data, and the controller 1 always adds and updates the map. Accordingly, since the map generation is separated from the posture identifying process in which a high-speed computing process time is necessary, it is possible to lighten the computing process carried out by the robot 2, and it is possible to make the robot inexpensive.

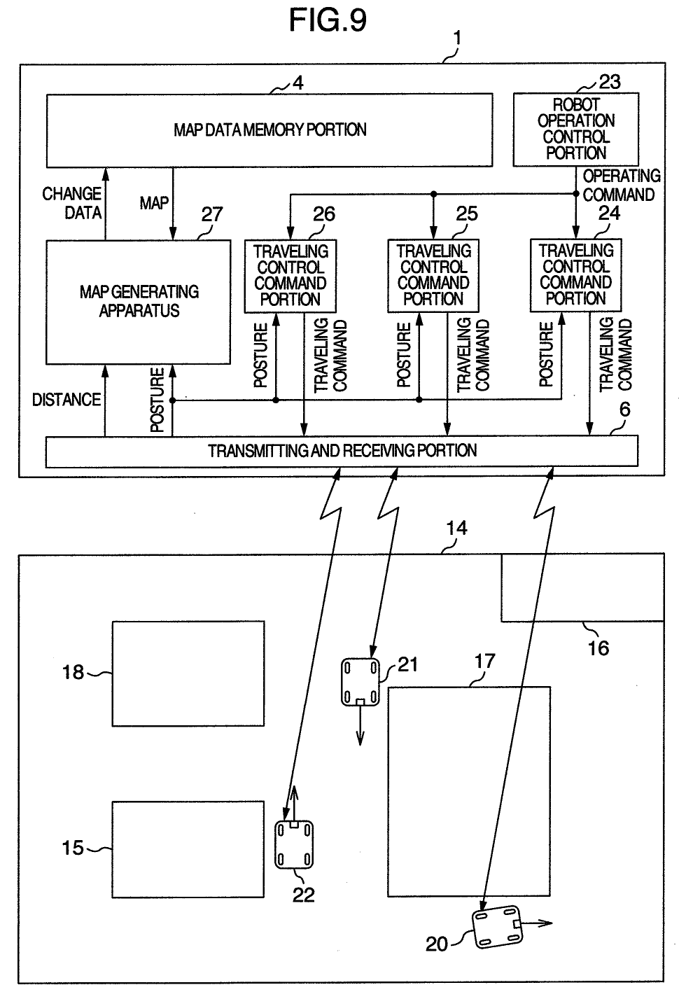

FIG. 9 shows an embodiment of a system in which a plurality of robots are operated by the controller 1. The robots 20, 21 and 22 are operated in the operating region 14, and each of the robots is controlled by the controller 1. The controller 1 in FIG. 9 is constructed by a robot operation control portion 23, traveling control command portions 24, 25 and 26, a map generating apparatus 27, a map data memory portion 4, and a transmitting and receiving portion 6. The robot operation control portion 23 is structured such as to control an operating method of the robots 20, 21 and 22, and has a function of applying a command so as to move each of the robots to a set position. On the basis of the operation command, the traveling control command portions 24, 25 and 26 respectively output the traveling commands to the robots 20, 21 and 22, and controls their motions. The processing methods are the same as the method described about the traveling control command portion 3 in FIG. 3. The robots 20, 21 and 22 move and stop on the basis of the traveling commands. Further, as explained in the embodiment in FIG. 5, each of the robots identifies its self posture, and outputs the result to the traveling control command portions 24, 25 and 26 and the map generating apparatus 27.

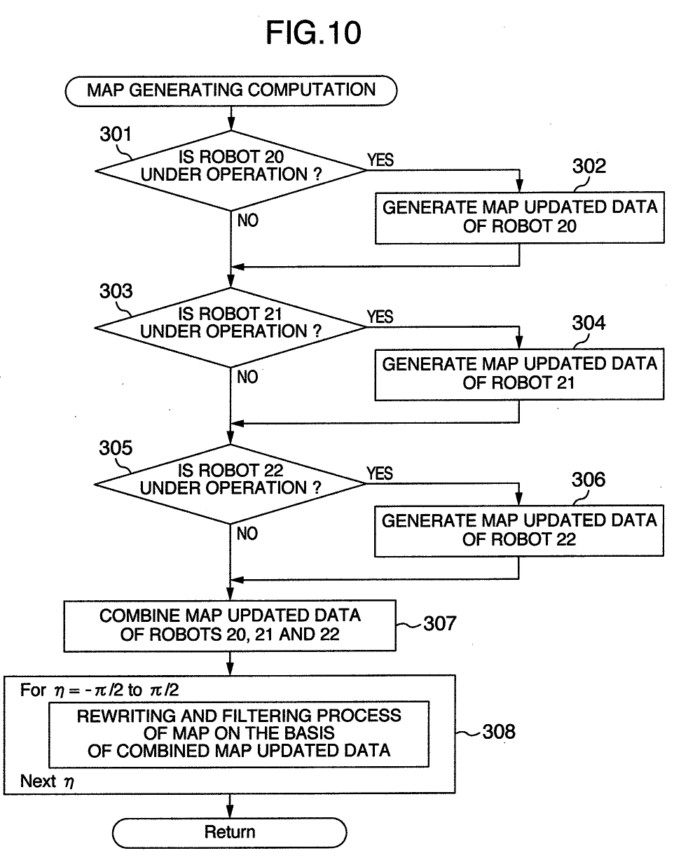

Next, a description will be given of a characteristic map generating apparatus 27 in the present embodiment with reference to FIG. 10. A step 301 determines whether or not the robot 20 is under operation, and a process of a step 302 is carried out in the case that the robot is under operation, and the step jumps to a step 303 in the case that the robot 20 is not under operation. The step 302 is structured such as to generate the map updated data of the robot 20, and carries out the same process as the processing method explained in FIG. 8 in a range which can be detected by the distance sensor of the robot 20. Since any new information can not be obtained in the case that the robot 20 is not under operation, the process of the step 302 is not carried out. Steps 303 and 304 and steps 305 and 306 generate the map updated data respectively aiming at the robot 21, and aiming at the robot 22. The map updated data obtained by these processes are combined in a step 307. As a result, if the information obtained by three robots is brought together to one map updated data, it is possible to carry out a map rewriting and filtering process, and update the map including the new information in the next step 308.

In this case, a difference between the conventional system and the present embodiment is put together. First, a description will be given of a case of a system of carrying out all the identification of the posture of the robot and the map generation by the controller 1, as one of the conventional system. In this case, there is a problem that the computation is enormous for identifying the postures of a lot of robots, and it takes a long time to obtain the result of computation. In other words, in the feedback control of the robot on the basis of the posture identifying result, it is impossible to achieve a high-speed response. Further, as the other case of the conventional system, in the system in which the robot carries out the posture identification and the map generation, there exist a plurality of maps generated only by the information collected by the robots, and there is a problem that it is impossible to make good use of the latest information obtained by the other robots. On the contrary, in accordance with the embodiment in FIGS. 9 and 10, it is possible to identify the posture of the robot without enlarging the computing load of the robot in the system in which a plurality of robots are operated. Further, since it is possible to collect the information from a plurality of robots in the controller 1 so as to generate the map in a unified manner, all the robots are controlled on the basis of the same map information, and are moved. Accordingly, since it is possible to identify the posture of the robot on the basis of the latest map information including the information collected by the other robots, it is possible to carry out the identification having higher reliability and precision.

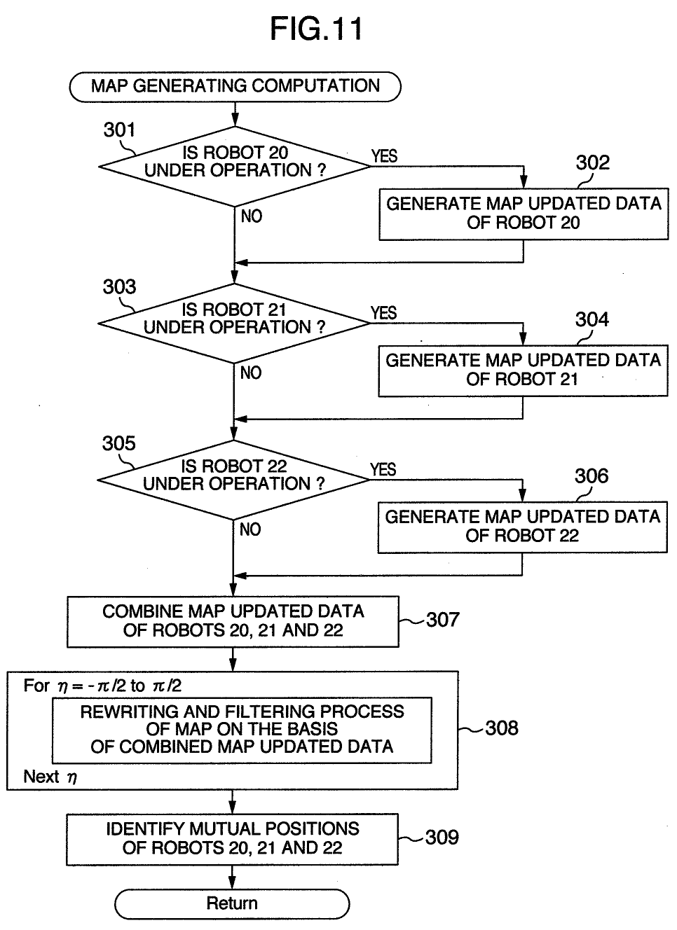

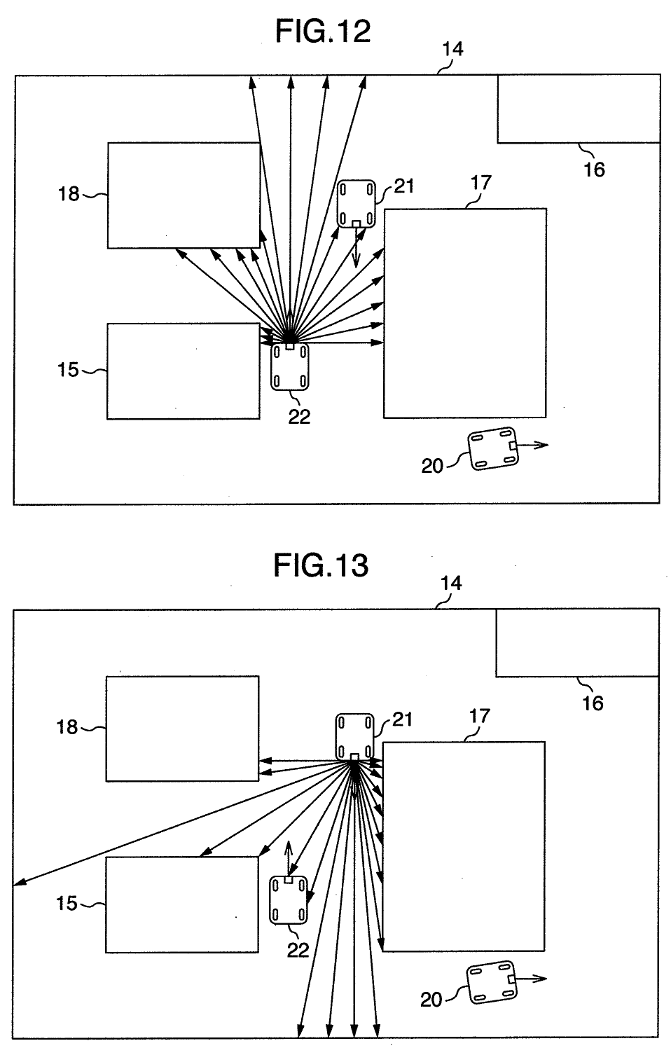

FIG. 11 shows the other embodiment in which the computation of the map generating apparatus 27 in the embodiment in FIGS. 9 and 10 is different. In comparison with FIG. 10, a computation of a step 309 is added, and is an effective process in the case that a plurality of robots are operated. For example, there is considered a case that the robot 21 and the robot 22 can detect as the map updated date by the distance sensors, as shown in FIGS. 12 to 14. Since the robot 22 detects a distance in a range shown in FIG. 12 by a distance sensor mounted thereon, the map updated data including the robot 21 is generated in a step 306 in FIG. 11. Further, with regard to the robot 21, the map updated date including the robot 22 is generated in a step 304 in FIG. 11, as shown in FIG. 13.

The step 309 collates the postures of all the robots input to the map generating apparatus in FIG. 9 with the map updated date obtained in the steps 302, 304 and 306 in FIG. 11, and determines whether or not the position of the robot is correctly identified. In the case of determining that the position of the robot is not correctly identified, the step carries out a process of giving an alarm or stopping the system, as an abnormal robot position identification.

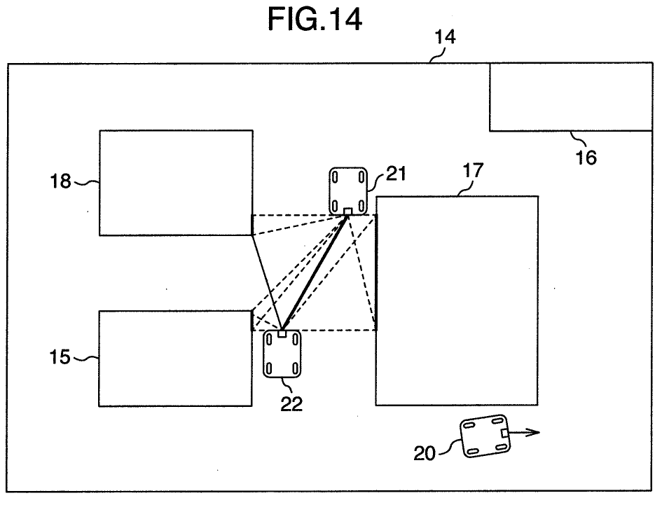

Further, as shown in FIG. 14, in the case that the robot 21 and the robot 22 face to each other, the step check out whether or not the distance between the robot 21 and the robot 22 is correctly measured within the error precision range, on the basis of the information of the postures and the distances of the mutual robots. In accordance with this method, it is possible to secure a high reliability of the distance sensor mounted to the robot. Further, with regard to the range of the object simultaneously measured by two robots, it is possible to generate the map at a high precision on the basis of a principle of triangulation. In the case of FIG. 14, a part of a left side of the object 17 expressed by a thick line, a right side of an upper portion of the object 15, and a right side of a lower portion of the object 18 correspond thereto. As mentioned above, there is achieved a characteristic that it is possible to construct the system having a high reliability by identifying the positions of the robots mutually by a plurality of robots, and it is possible to contribute to a high precision of the map generation.

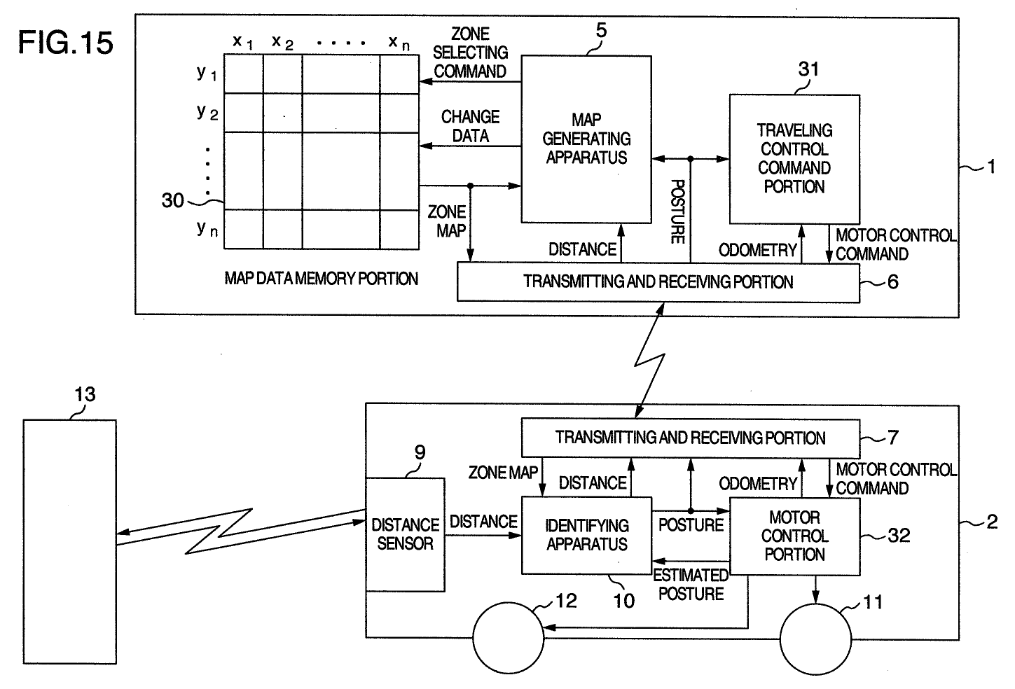

FIG. 15 shows an embodiment of the robot system moving in a wide rage of region, and utilizes only a map in the vicinity of the position at which the robot exists in the wide range of map data for identifying the posture of the robot. Hereinafter, the map in the vicinity of the robot is called as a zone map. The embodiment of FIG. 15 is different from FIG. 1 in a point of a processing method of the map data memory portion 30, the traveling control command portion 31 and the motor control portion 32.

The traveling control command portion 31 determines the traveling command in accordance with the same method as the traveling control command portion 3 in FIG. 1. Next, the rotating speeds of the wheels 11 and 12 and the steered angles detected by the robot 2 are input to the traveling control command portion 31. In this case, the rotating speeds and the steered angles are called as an odometry. Further, the posture identified by the identifying apparatus 10 of the robot 2 is input to the traveling control command portion 31. The latest posture of the robot 2 is estimated on the basis of the input posture and the odometry, thereby carrying out the feedback control of the posture of the robot 2 with respect to the traveling command. The motor control command of each of the motors driving the wheels 11 and 12 is input to the robot 2 on the basis of the result. The motor control portion 32 of the robot 2 carries out the motor control on the basis of the motor control commands and drives the robot 2.

Further, a characteristic point of the present invention is the data input to and output from the map data memory portion 30. The map generating apparatus 5 determines what zone the robot 2 exists, on the basis of the posture of the robot 2, and outputs a zone selecting command to the map data memory portion 30. On the basis of the zone selecting command, the zone map in which the robot exists is output to the identifying apparatus 10 of the robot 2 from the map data memory portion 30. The identifying apparatus 10 is the same as the embodiment in FIG. 1, and carries out a process of identifying the posture of the robot 2 on the basis of the zone map. In this cases, the change data output to the map data memory portion 30 from the map generating apparatus 5 is not limited to the range of the zone map, but is based on the map updated data obtained from the distance data measured by the robot 2.

In the case that the robot moves outside the set zone, there is a characteristic that the map can be automatically rewritten to the zone map required by the robot 2, by changing the zone selecting command. Accordingly, since it is possible to identify the posture of the robot, generate and update the map without enlarging the memory apparatus required by the map of the robot, in the robot system moving around the wide range or region, by using the present embodiment, there is obtained an advantage that it is possible to comparatively inexpensively provide the robot system moving in the wide range of operating region such as a factory, a physical distribution center or the like.

The above is the embodiment applied to the robot system operated in the predetermined operating region such as the factory, the physical distribution center or the like, however, the present invention can be applied to a robot system operating in a building or a hospital. With regard to the system operated by one robot and the system operated by a plurality of robots, the description is given of the method of controlling the robot in accordance with the different control methods as the embodiment, however, it is effective to employ a method obtained by combining these methods. Further, as is mentioned above, since it is not necessary for the robot to operate in the self-sustaining manner in the case of the robot system aiming at the map generation, the vehicle operated or pushed by the human being correspond to the robot in accordance with the present invention, and the present invention can be applied thereto. Therefore, the present invention is not limited to the method mentioned in the present embodiment, but the present invention can be widely applied to the case using a plurality of combinations together.

It should be further understood by those skilled in the art that although the foregoing description has been made on embodiments of the invention, the invention is not limited thereto and various changes and modifications may be made without departing from the spirit of the invention and the scope of the appended claims.

1. A robot system constructed by a controller having a map data and a mobile robot, wherein said robot comprises:
a distance sensor measuring a plurality of distances with respect to a peripheral object; and
an identifying apparatus identifying a position and an angle of said robot by collating with said map data, and
wherein said controller comprises:
a map generating apparatus generating or updating said map data on the basis of the position and the angle of said robot, and the measured distance with respect to said object.

2. A robot system constructed by a controller having a map data and a plurality of mobile robots, wherein said robot identifies a position and an angle of said robot by measuring a plurality of distances with respect to a peripheral object, and collating the map data input from said controller, and said controller generates or updates said map data on the basis of the distance with respect said object measured by said plurality of robots and said position and angle.

3. A robot system constructed by a controller having a map data and a mobile robot, wherein said robot comprises:
a distance sensor measuring a plurality of distances with respect to a peripheral object;
a data selecting apparatus selecting a region map data near the robot in said map data; and
an identifying apparatus identifying a position and an angle of said robot by collating said region map with said distance, and
wherein said controller comprises:
a map generating apparatus generating or updating said map data on the basis of the position and the angle of said robot, and the measured distance with respect to said object.

4. A robot system constructed by a controller having a map data and a mobile robot, wherein said robot comprises:
a distance sensor measuring a plurality of distances with respect to a peripheral object;
a memory apparatus storing a region map data near the robot in said map data; and
an identifying apparatus identifying a position and an angle of said robot by collating said region map with said distance, and
wherein said controller comprises:
a map generating apparatus generating or updating said map data on the basis of the position and the angle of said robot, and the measured distance with respect to said object.

5. A robot system as claimed in claim 1, wherein said distance sensor is constituted by a laser distance meter.

6. A robot system as claimed in claim 2, wherein said distance sensor is constituted by a laser distance meter.

7. A robot system as claimed in claim 3, wherein said distance sensor is constituted by a laser distance meter.

8. A robot system as claimed in claim 4, wherein said distance sensor is constituted by a laser distance meter.

9. A robot system as claimed in claim 1, wherein said robot moves in a self-sustaining manner on the basis of said position and the angle of said robot and a motion instruction from said controller, after identifying the position and the angle of the robot.

10. A robot system as claimed in claim 2, wherein said robot moves in a self-sustaining manner on the basis of said position and the angle of said robot and a motion instruction from said controller, after identifying the position and the angle of the robot.

11. A robot system as claimed in claim 3, wherein said robot moves in a self-sustaining manner on the basis of said position and the angle of said robot and a motion instruction from said controller, after identifying the position and the angle of the robot.

12. A robot system as claimed in claim 4, wherein said robot moves in a self-sustaining manner on the basis of said position and the angle of said robot and a motion instruction from said controller, after identifying the position and the angle of the robot.

13. A robot system as claimed in claim 2, wherein said plurality of robots mutually identify the positions of the robots.

14. A robot system as claimed in claim 3, wherein said region map data is changed on the basis of the identified position of the robot.

15. A robot system as claimed in claim 4, wherein said region map data is changed on the basis of the identified position of the robot.

16. A robot system as claimed in claim 13, wherein said region map data is changed at a time when the position of said robot is moved at a predetermined distance or more from the position of the robot at a time of selecting or storing said region map data.
